(19) United States
(12) Patent Application Publication
(10) Pub. No.: US 2024/0378946 A1
(43) Pub. Date: Nov. 14, 2024

(54) Simulated Dealer System

(71) Applicants: Crystal Robens, Ashland, VA (US); Stephen Robens, Ashland, VA (US); Jonathan Blair, Henderson, NV (US)

(72) Inventors: Crystal Robens, Ashland, VA (US); Stephen Robens, Ashland, VA (US); Jonathan Blair, Henderson, NV (US)

(21) Appl. No.: 18/661,141

(22) Filed: May 10, 2024

Related U.S. Application Data
(60) Provisional application No. 63/465,624, filed on May 11, 2023.
(60) Provisional application No. 63/466,045, filed on May 12, 2023.

(51) Int. Cl. G07F 17/32

(52) U.S. Cl. CPC G07F 17/3216; G07F 17/3211; G07F 17/3293

(57) ABSTRACT

A simulated dealer system that allows physical playing card handling without a dealer and to allow for standard card game play to occur without the use of a random number generator or a live dealer and comprises of a robotic dealing “arm” (“SimuDealer”), capable of simulating the motions of a live dealer, that deals cards into a defined random pattern, based on number of players, game, and game rules, and collects the cards to return to be shuffled and dealt in a continuous and autonomous system, all having an option to be remotely digitally monitored (on a delay) by players.

### BACKGROUND OF THE INVENTION

Casino games are played in many variations, with players playing against the house, where the house has cards or tiles/dominoes and the players have cards or tiles/dominoes and players win based on outranking the house, games with community cards only where the players hold cards and the combination of their cards with community cards determine win, loss, or draw, or a combination of the two where the dealer holds cards, the players hold cards and they both share community cards to create a winning or losing hand. A gaming establishment earns money by predetermining the payout for player wins to include a percentage of statistical wins for the establishment for player perfect strategy play, also known as the “house edge” and/or by collecting a rake or commission. Player actions include placing wagers, “holding” or keeping their cards or “folding” or relinquishing their cards based the cards/tiles they hold and/or the community cards/tiles or dealer cards/tiles revealed, and hitting or receiving additional cards. Dealer actions (with or without mechanized or electronic assistance) include shuffling cards/tiles, providing cards/tiles to players, dealing “burn” or intentionally discarded cards/tiles, dealing community (shared) cards/tiles, dealing banker hands, performing banker actions, including dealing additional banker hands, collecting folded and completed cards/tiles, collecting wagers, collecting commissions, and providing the winning wagers to the winning player(s).

The game of poker is played in a player versus player method, with a gaming establishment earning money by collecting a “rake” or percentage of the total wagers placed on a game, depending on the actions of the players. Player actions include placing antes and wagers, and “holding” or keeping their cards or “folding” or relinquishing their cards based on the wagers of other players. Dealer actions (with or without mechanized or electronic assistance) include shuffling cards, providing cards to players, dealing “burn” cards, dealing community (shared) cards, collecting folded and completed cards, collecting wagers, collecting the rake, and providing the remaining collected wagers to the winning player(s).

Gaming establishments provide for live gaming with (1) a Live Dealer shuffling and dealing one or many decks of cards manually (i.e. without the assistance of an automatic card shuffler) with or without a secondary deck of cards, (2) a Live Dealer dealing one or many decks of cards with an opaque automatic card shuffler (continually or for a period of time shuffling a secondary deck of cards), or (3) play by electronic means, employing a random number generator or natural number generator and providing a digital display to players for their actions. Players select a means of play based on their overall trust of the gaming establishment, their procedures, and their own preference. Players may perform actions by signaling the dealer or by electronic means, depending on gaming or establishment preferences, rules, and regulations. Many gaming establishments have existing agreements with providers of opaque card shuffling machines, and the SimuDealer system would be able to directly connect to those, if desired by the gaming establishment, or it may provide a complete cycle, including card shuffling by means of a transparent card shuffler

Gaming establishments provide for poker gaming with (1) a Live Dealer shuffling and dealing a single deck of cards manually (i.e. without the assistance of an automatic card shuffler) with or without a secondary deck of cards, (2) a Live Dealer dealing a single deck of cards with an opaque automatic card shuffler (continually shuffling a secondary deck of cards), or (3) play by electronic means, employing a random number generator or natural number generator and providing a digital display to players for their actions. Players select a means of play based on their overall trust of the gaming establishment, their procedures, and their own preference. Players may perform actions by signaling the dealer or by electronic means. Many gaming establishments have existing agreements with providers of opaque card shuffling machines, and the SimuDealer system would be able to directly connect to those, if desired by the gaming establishment, or it may provide a complete cycle, including card shuffling by means of a transparent card shuffler.

Many players prefer to avoid random number generators or automatic card shufflers, due to distrust of the mechanisms therein, however, using a live dealer shuffling and dealing cards manually is the slowest, most expensive, and most error-prone way of dealing cards to consumers. It is also limited to physical spaces or select remote options.

### SUMMARY OF THE INVENTION

There is a need for a system that allows casino playing cards to be dealt without a dealer to allow for standard card game play to occur without the use of a random number generator or a live dealer.

The present subject matter comprises of a card dealing “arm” (“SimuDealer”), capable of simulating the motions of a live dealer, that deals cards into a defined pattern, based on number of players, game, and game rules, and collects the cards to return to be shuffled and dealt, with or without the ability to be remotely recording/video monitored (on a delay) by players. The arm will travel along a track, either in a straight or curved line. The arm will be covered in a sleeve, to mimic the appearance of a live dealer's arm. The arm may or may not be accompanied by a holographic or other transparent visual representation of a dealer's face and body. Whether there is a visual manifestation or not, the SimuDealer can provide verbal direction, make and respond to verbal requests, and may include jovial material based on particular actions, requests, or motions. In some iterations, capability to respond to physical or verbal cues (typical for table or poker gambling) will be included.

There is also a return mechanism for collecting cards beneath a playing table, returning them to a card shuffler and a deal bumper (CardBumper) reducing errors by collecting cards automatically from players.

The present subject matter would introduce a new means of play, simulating a live dealer (SimuDealer) with a device capable of dealing a single or multiple decks of cards, with or without live video of the mechanisms available for player viewing (on a delay to ensure fair live game play), simulating the live dealer experience in a way that reduces errors for the gaming establishment and players. SimuDealer would function by using repeatable mechanical motions, with minute natural and mechanized variations, providing random variations to produce true natural randomness without use of a random number generator, all while providing a trust-building experience for the player by being able to view all of the mechanisms, in person or remotely, or by employing collaborative robotic technology to perform mechanical actions with the assistance of a live dealer who is not handling the cards directly. To alleviate security concerns, all algorithms will be hard-coded into the SimuDealer, with no remote or wifi access to make changes to the mechanical motions. Furthermore, the device will be made of a material that is resistant to outside manipulations, e.g. magnets.

In some embodiments, encoded machine-readable cards and RFID or other machine readers would simulate live play (dealer and player actions), allowing players to be located in a remote location, viewing the play by either live video feed, or by display of the RFID encoded information on the cards. After viewing their cards, as player actions are undertaken, the player card display would be turned off or on based on those actions, simulating the “folding” of player hands. After conclusion of the game play, player cards would be collected by a mechanism beneath the playing table and returned to the backup card shuffler(s).

In some embodiments, encrypted machine-readable/RFID encoded cards/tiles and machine/RFID readers would simulate live dealer play only, allowing for players to have a live dealer experience handling cards physically, while performing player actions in a live setting with other live players. RFID encoded cards or tiles would be read by the system, and the natural winner would be determined by the encoding of the cards. A win/lose indicator will notify the player and casino of the machine's determination of the winner, and a supervisor may override decisions based on casino discretion, with an override passcode. An override audit will be able to be performed at any time, physically from the system.

In some embodiments, the present subject matter involves collaborative automation wherein a human dealer may assist the machine dealer in performing certain motions.

In some embodiments, the present subject matter involves a holographic representation of a live dealer, to direct game play verbally and provide entertainment.

In some embodiments, the present subject matter involves an artificial intelligences, capable of responding to verbal cues including, but not limited to, disallowed “table talk”, verbal betting (poker), and frequently asked questions.

In some embodiments, playing cards may be replaced by playing “tiles” or dominos for game play.

### BRIEF DESCRIPTION OF DRAWINGS

FIG. 1 shows a diagram of variation 1 of the simulated dealer system when some players are playing remotely and community cards are in play.

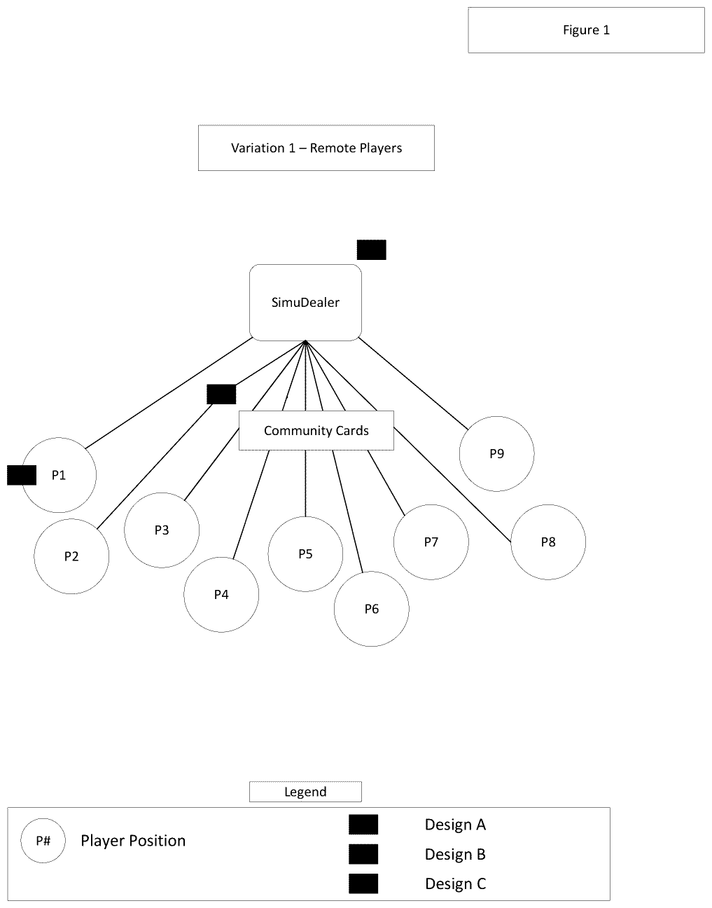

FIG. 2 shows a diagram of variation 2 of the simulated dealer system when the players are all playing in person and community cards are in play.

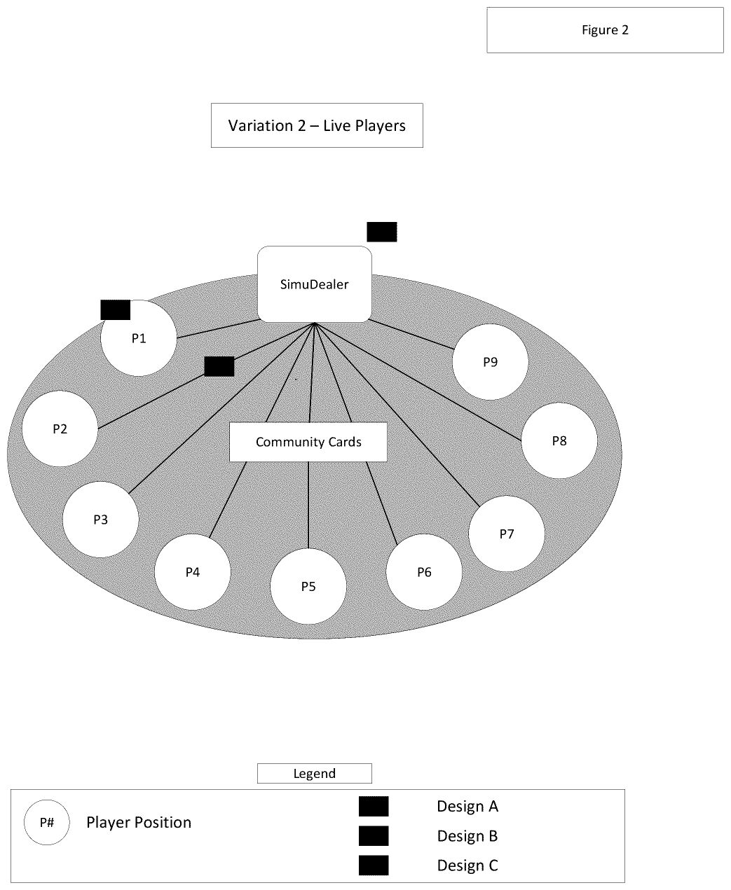

FIG. 3 shows a diagram of variation 3 of the simulated dealer system when the SimuDealer is assisted by collaborative technology to mimic the motions of a live dealer remotely, and community cards are in play.

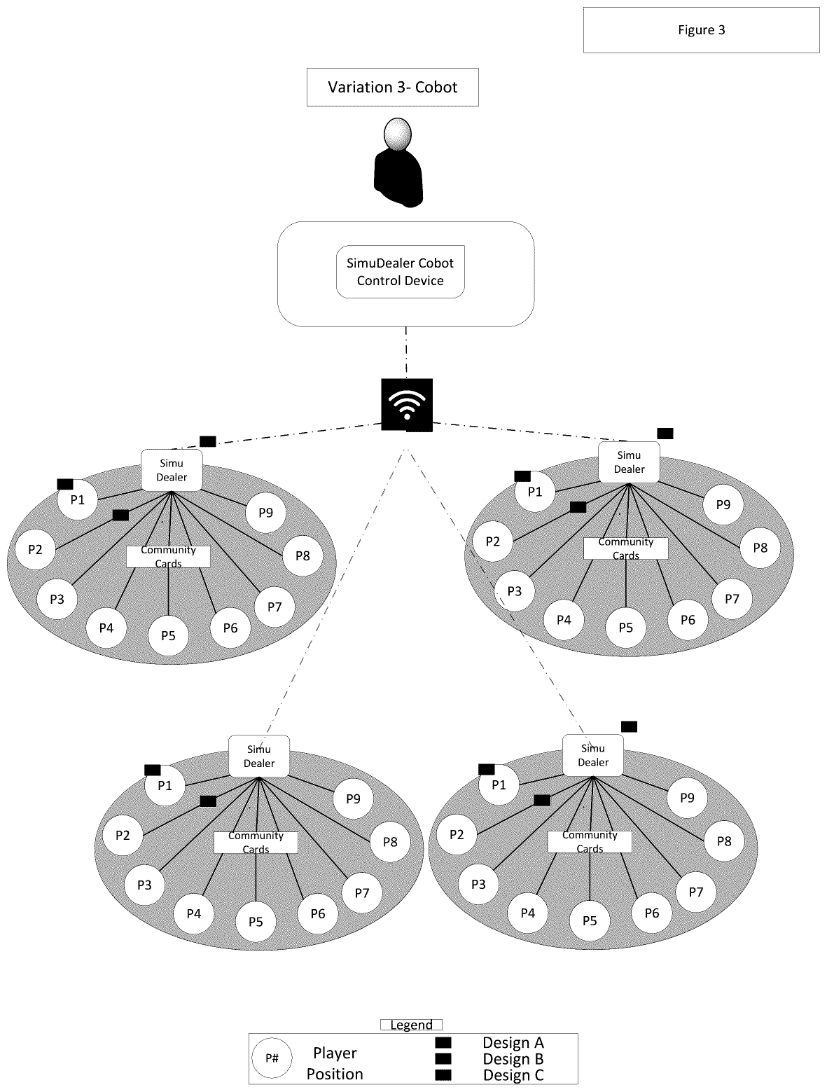

FIG. 4 shows a diagram of variation 4 of the simulated dealer system when some players are playing remotely and there are no community cards in play.

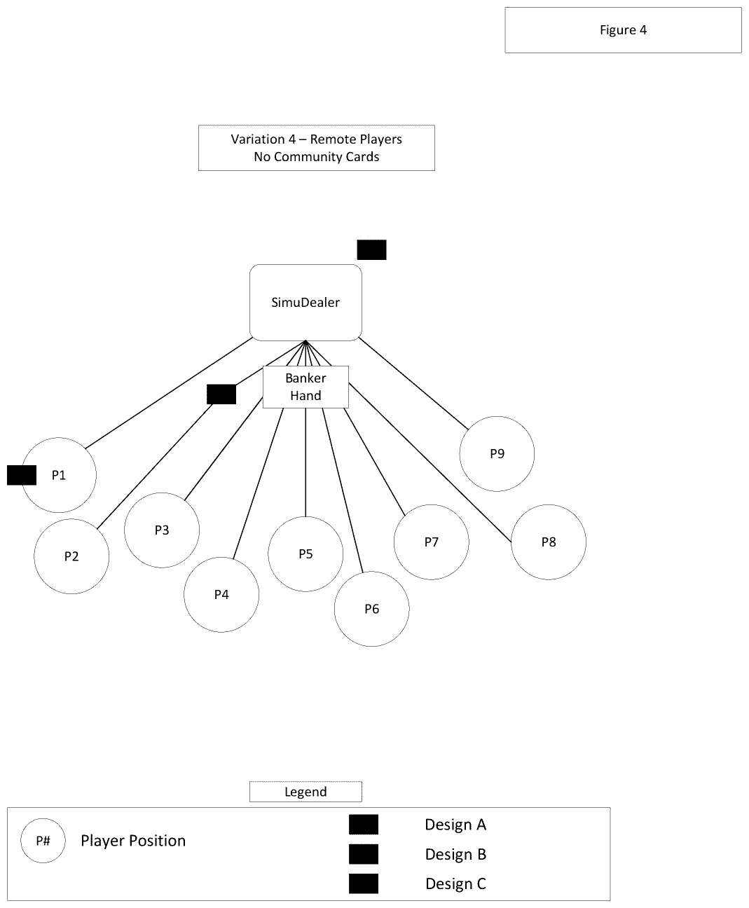

FIG. 5 shows a diagram of variation 5 of the simulated dealer system when players are playing in person and no community cards are in play.

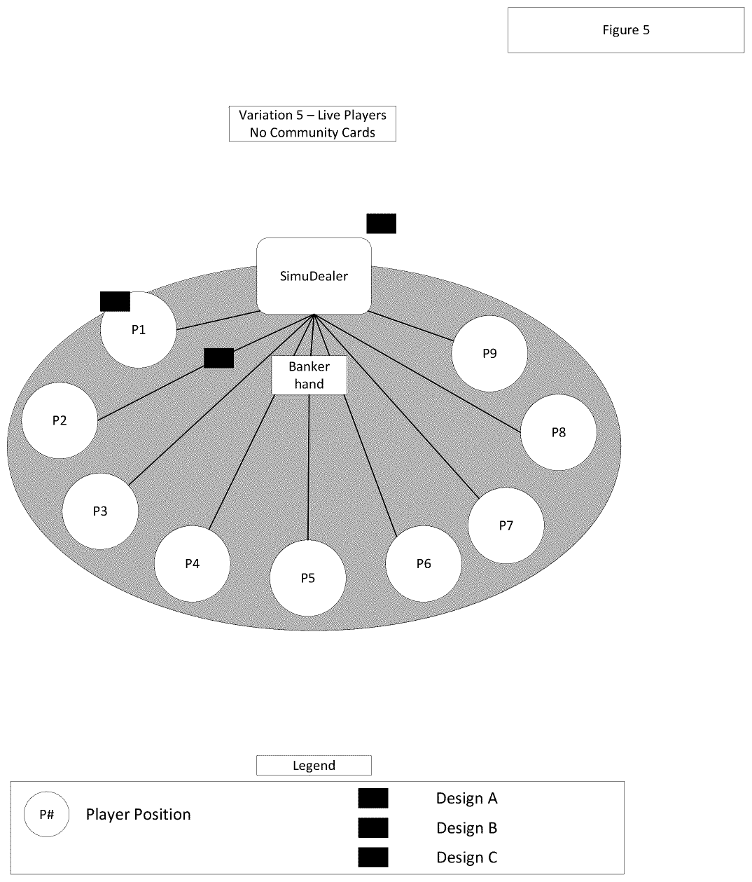

FIG. 6 shows a diagram of variation 6 of the simulated dealer system when the SimuDealer is assisted by collaborative technology to mimic the motions of a live dealer remotely, and no community cards are in play.

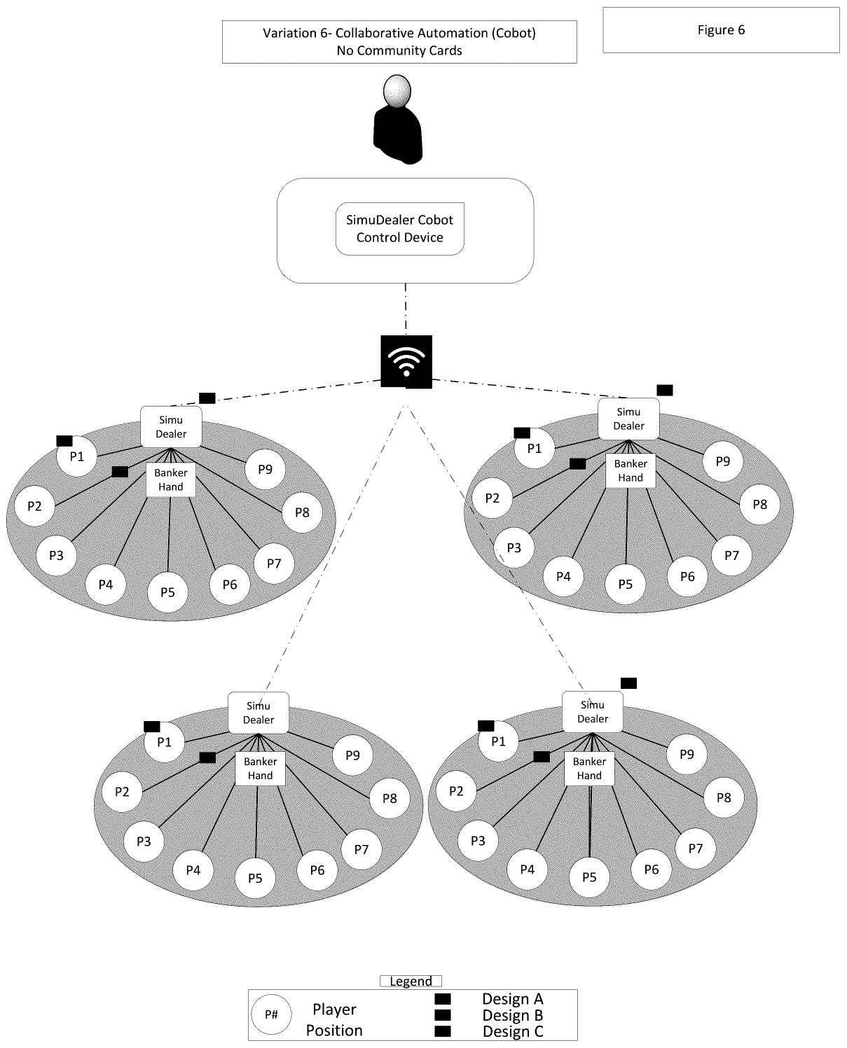

FIG. 7 shows a side view of a simulated dealer system.

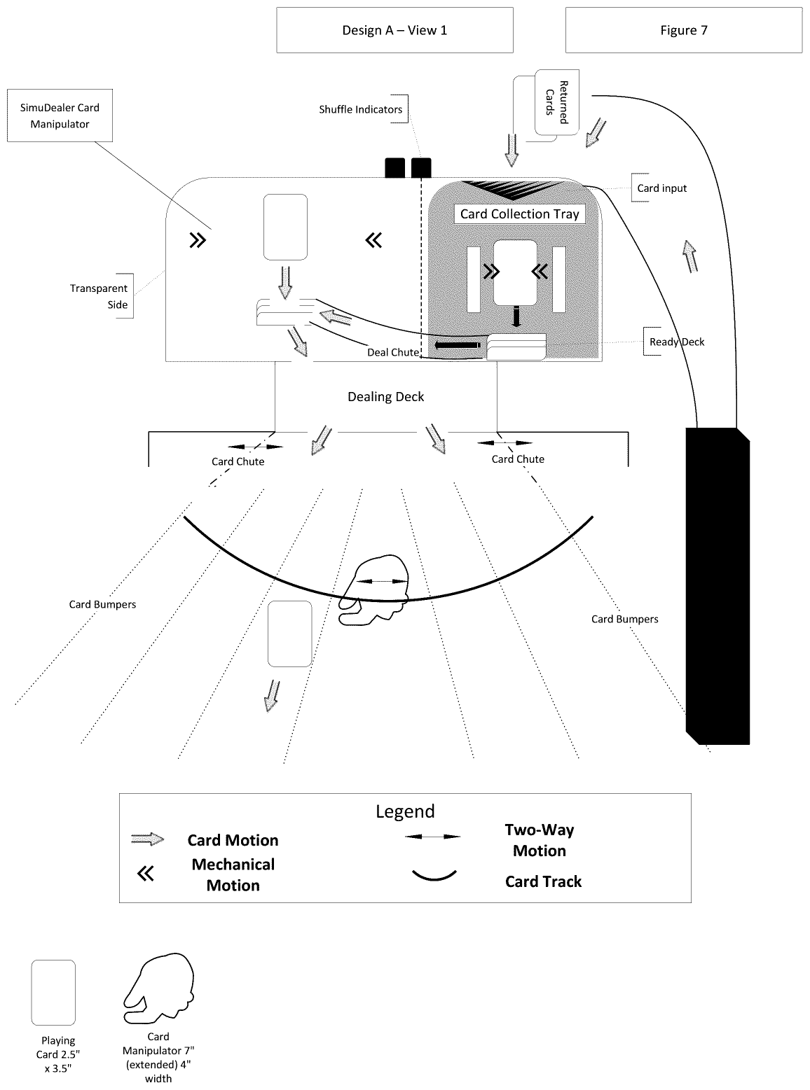

FIG. 8 shows a diagram of vertical card readers with retracting dividers and RFID readers.

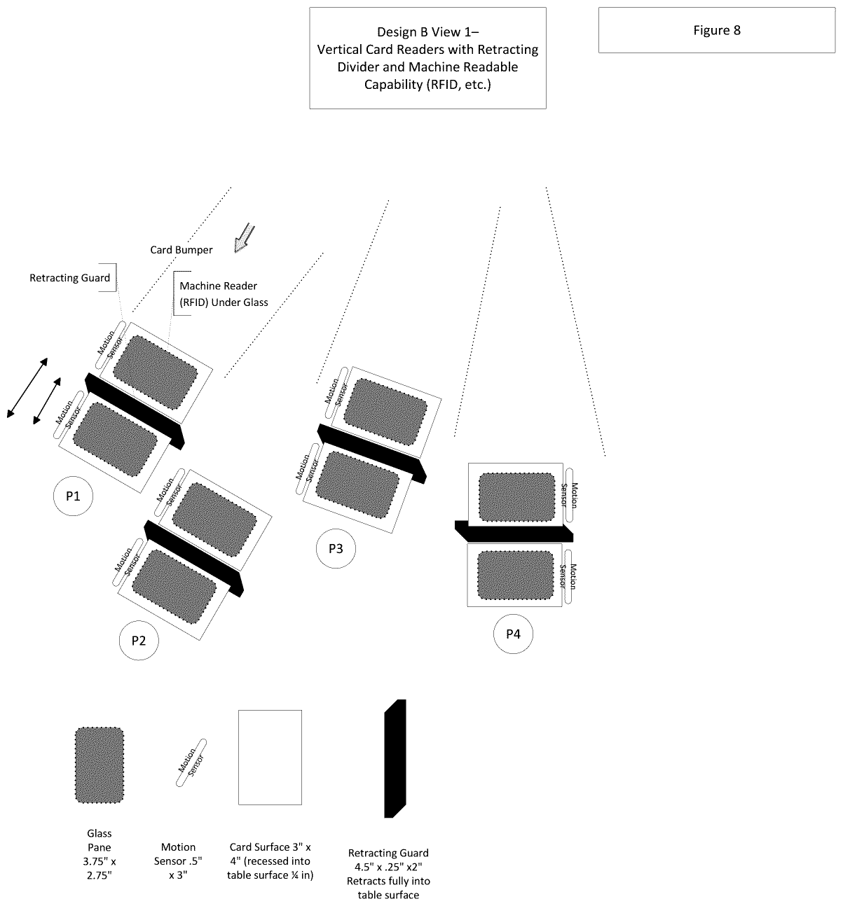

FIG. 9 shows a side view of the card return system.

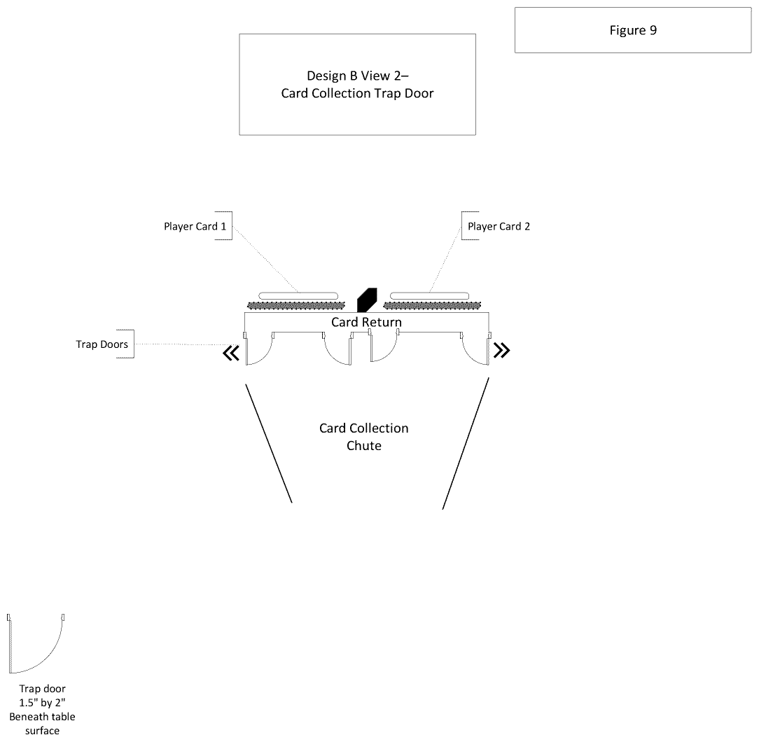

FIG. 10 shows a cut away view of the card return system.

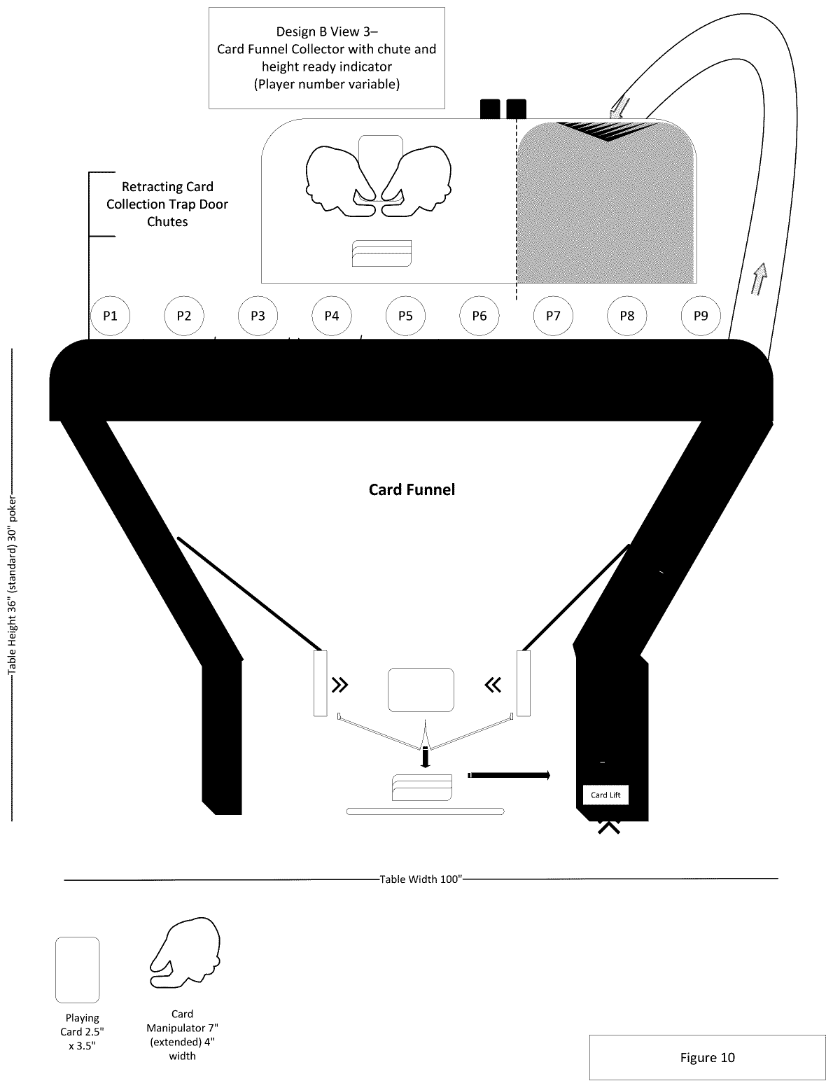

FIG. 11 shows a diagram of the card bumper system.

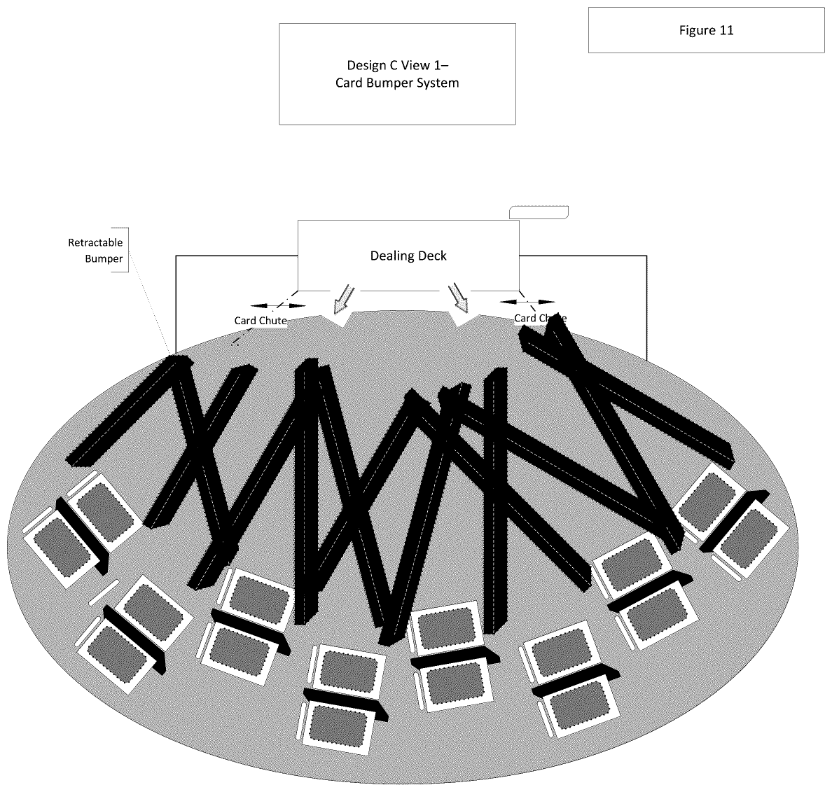

FIG. 12 shows a diagram of a community card system.

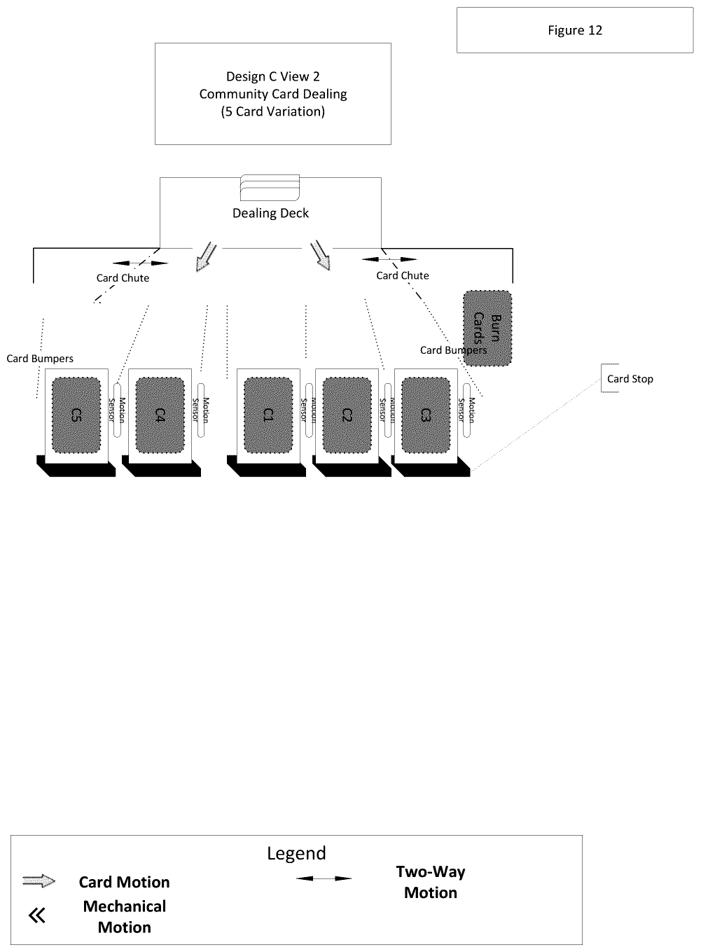

FIG. 13 shows a diagram of a 3-card variation of the community card system.

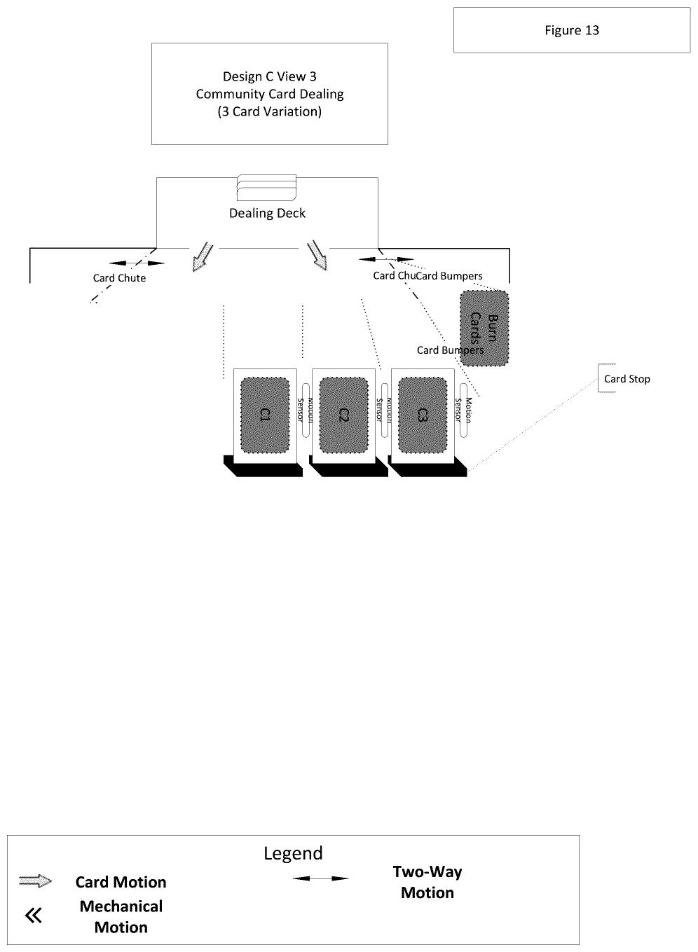

FIG. 14 shows a variation 8 of a simulated dealer system with a holographic assistant

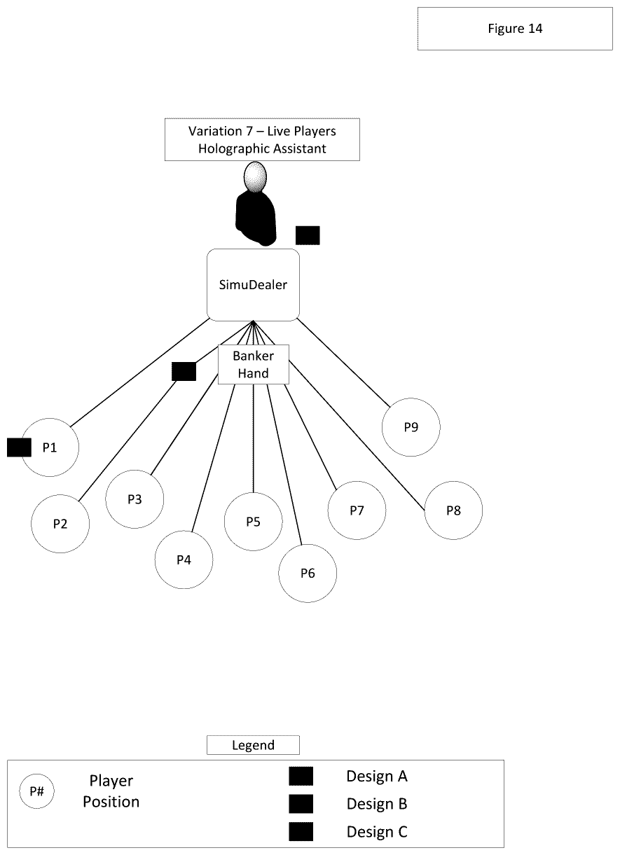

FIG. 15 shows a variation 8 of the simulated dealer system when the SimuDealer is used to distribute tiles or blocks rather than cards.

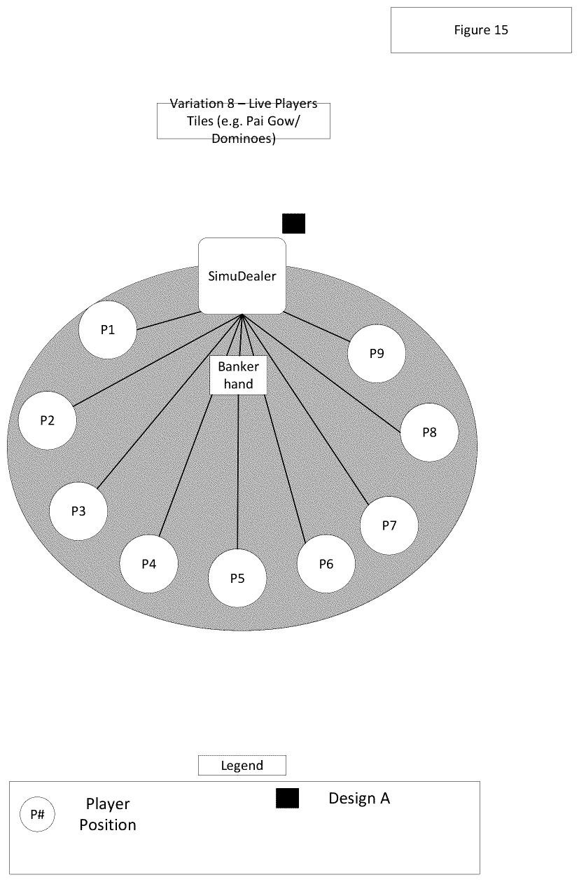

1. A simulated dealer system meant for in-person, hybrid, and remote play comprising of a robotic card dealing arm, a card dealing track, a return mechanism, a deal bumper, a recording monitoring system, and machine-readable cards or tiles.

2. The simulated dealer system meant for in-person, hybrid, and remote play comprising of the robotic card dealing arm, a card dealing track, return mechanism, deal bumper, recording monitoring system, and machine-readable cards as in claim 1, wherein the system distributes cards using a defined pattern based on the number of players, game, and game rules.

3. The simulated dealer system meant for in-person, hybrid, and remote play comprising of the robotic card dealing arm, a card dealing track, return mechanism, deal bumper, recording monitoring system, and machine-readable cards as in claim 1, wherein the recording is able to be monitored by players on a delay.

4. The simulated dealer system meant for in-person, hybrid, and remote play comprising of the robotic card dealing arm, a card dealing track, return mechanism, deal bumper, recording monitoring system, and machine-readable cards as in claim 1, wherein the return mechanism is beneath the playing table and returns the cards to the card shuffler.

5. The simulated dealer system meant for in-person, hybrid, and remote play comprising of the robotic card dealing arm, a card dealing track, return mechanism, deal bumper, recording monitoring system, and machine-readable cards as in claim 1, wherein the deal bumper reduces errors by providing cards automatically to players.

6. A method of using a simulated dealer system meant for in-person, hybrid, and remote play comprising of robotic card dealing arm, a card dealing track, a return mechanism, a deal bumper, a recording monitoring system, and machine-readable cards.

7. The method of using the simulated dealer system meant for in-person, hybrid, and remote play comprising of a robotic card dealing arm, a card dealing track, return mechanism, deal bumper, recording monitoring system, and machine-readable cards as in claim 6, wherein the shuffler uses a defined pattern based on the number of players, game, and game rules.

8. The method of using the simulated dealer system meant for in-person, hybrid, and remote play comprising of a robotic card dealing arm, a card dealing track, return mechanism, deal bumper, recording monitoring system, and machine-readable cards as in claim 6, wherein the video is able to be monitored by players on a delay.

9. The method of using the simulated dealer system meant for in-person, hybrid, and remote play comprising of a robotic card dealing arm, a card dealing track, return mechanism, deal bumper, recording monitoring system, and machine-readable cards as in claim 6, wherein the return mechanism is beneath the playing table and returns the cards to the card shuffler.

10. The method of using the simulated dealer system meant for in-person, hybrid, and remote play comprising of a robotic card dealing arm, a card dealing track, return mechanism, deal bumper, recording monitoring system, and machine-readable cards as in claim 6, wherein the deal bumper reduces errors by providing cards automatically to players.

11. A method of constructing simulated dealer system meant for in-person, hybrid, and remote play comprising of a robotic card dealing arm, a card dealing track, a return mechanism, a deal bumper, a recording monitoring system, and machine-readable cards.

12. The method of constructing simulated dealer system meant for in-person, hybrid, and remote play comprising of the robotic card dealing arm, a card dealing track, return mechanism, deal bumper, recording monitoring system, and machine-readable cards as in claim 11, wherein the shuffler uses a defined pattern based on the number of players, game, and game rules.

13. The method of constructing simulated dealer system meant for in-person, hybrid, and remote play comprising of the robotic card dealing arm, a card dealing track, return mechanism, deal bumper, recording monitoring system, and machine-readable cards as in claim 11, wherein the video is able to be monitored by players on a delay.

14. The method of constructing simulated dealer system meant for in-person, hybrid, and remote play comprising of the robotic card dealing arm, a card dealing track, return mechanism, deal bumper, recording monitoring system, and machine-readable cards as in claim 11, wherein the return mechanism is beneath the playing table and returns the cards to the card shuffler.

15. The method of constructing simulated dealer system meant for in-person, hybrid, and remote play comprising of the robotic card dealing arm, a card dealing track, return mechanism, deal bumper, recording monitoring system, and machine-readable cards as in claim 11, wherein the verbal play instructions are provided by a holographic or digital display of a simulated dealer.

16. The method of constructing simulated dealer system meant for in-person, hybrid, and remote play comprising of the robotic card dealing arm, a card dealing track, return mechanism, deal bumper, recording monitoring system, and machine-readable cards, wherein the verbal play instructions are responded to by a simulated dealer, using machine learning or artificial intelligence.

17. The method of constructing simulated dealer system meant for in-person, hybrid, and remote play comprising of the robotic card dealing arm, a card dealing track, return mechanism, deal bumper, recording monitoring system, and machine-readable cards as in claim 16, wherein the physical betting or play instructions are responded to by a simulated dealer, using machine learning or artificial intelligence.
